(19) United States
(12) Patent Application Publication
(10) Pub. No.: US 2007/0146362 A1
(43) Pub. Date: Jun. 28, 2007

(54) Automatic drawing creation system

(75) Inventors: Shinichi Yanagishita, Ayase-shi (JP); Masaki Ikeda, Naka-gun (JP)

Correspondence Address: CROWELL & MORING LLP;INTELLECTUAL PROPERTY GROUP, P.O. BOX 14300, WASHINGTON, DC, 20044-4300, US

(73) Assignee: NSK Ltd., Shinagawa-ku (JP)

(21) Appl. No.: 10/594,425

(22) PCT Filed: Jun. 21, 2005
(86) PCT No.: PCT/JP05/11364

§ 371 Date: Sep. 26, 2006

(30) Foreign Application Priority Data
Sep. 22, 2004 (JP) 2004-275263

(51) Int. Cl. G06T 17/00

(52) U.S. Cl. 345/420

(57) ABSTRACT

An automatic drawing creation system in which dimension lines required for a two-dimensional drawing are automatically written when the two-dimensional drawing is created from a three-dimensional model. A product specification determination means 10 creates a three-dimensional model which is then held while being associated with its attribute values. After a specified drawing frame is extracted from a drawing frame database 18 by an automatic drawing creation means 22, a two-dimensional projection drawing is created on the extracted drawing frame by projecting the three-dimensional model. Then, dimension line elements dependent on the shape of the two-dimensional projection drawing is extracted from a dimension database 16 and deformed according to attribute values of a product, a required dimension line element 28 and the two-dimensional projection drawing are compounded by an automatic drawing creation means 26, and the compounded two-dimensional projection drawing is outputted as a drawing 30 from a drawing presentation means 24.

### TECHNICAL FIELD

The present invention concerns an automatic drawing creation system constituted so as to automatically create a machine drawing by using a computer.

### BACKGROUND ART

In a case of conducting machine design, for exchanging a contract with a customer or transmitting design information to a production plant, it is required to draw drawings in various forms in accordance with application uses or destinations. Then, it has been conducted to design a product shape by using CAD and prepare a drawing expressed in a two-dimension form. For example, a method of using a two-dimensional CAD, drawing lines in a predetermined drawing frame by a designer to finish as a drawing, or preparing a model by a three-dimensional CAD, projecting the same on a plane and adding and describing necessary items to finish a drawing has been adopted.

However, since a cubic product is expressed by a drawing expressed in a two-dimensional manner, a dimension for a portion that can not be expressed only by projection from the three dimensional CAD can not sometimes be described. On the other hand, since all shapes are prepared as ad vivum, those portions that may be allowed to be omitted in view of the drawing, for example, portions for repetitive patterns are described entirely and unnecessary dimensions are sometimes expressed in a complicate projection drawing. That is, in the three dimensional design, a three-dimensional object is defined by defining a cross sectional shape on every parts and by rotation or extrusion and conducting compounding with other three-dimensional model or elimination, thereby creating an optional shape. Accordingly, dimensional elements held in the three dimensional design can not sufficiently provide sizes necessary for two-dimensional expression. Further, in a case of an assembled product, since it is constituted by combination of parts expressed in a three dimensional manner, even unnecessary sizes are created and a designer is obliged to additionally describe or amend the dimension manually.

A subject of the present invention is to automatically describe dimensional lines required for a two-dimensional drawing upon creating a two-dimensional drawing from a three-dimensional model.

### DISCLOSURE OF THE INVENTION

For solving the subject, the present invention adopts an automatic drawing creation method of constructing a three-dimensional model by using a computer source having a processing device source, a memory source, an input device, and an interface, in which the processing device source executes a processing including; a step of extracting a designated drawing frame from a drawing frame data base that stores a drawing frame data on every application uses, a step of projecting a three-dimensional model extracted from a three-dimensional model data base on the extruded drawing frame thereby creating a 2-dimensional projection drawing, a step of extracting dimensional line elements in accordance with the shape of the two-dimensional projection drawing from a dimension data base that stores data concerning a plurality of dimensional line elements and deforming them in accordance with attribute values of a product, and a step of compounding the deformed dimension line elements and the two-dimensional projection drawing and outputting the two-dimensional projection drawing as a drawing based on an operation program of the memory source.

Upon adopting the automatic drawing creation method described above, when the deformed dimension line elements and the two-dimensional projection drawing are compounded, a step of extracting designated tolerance values and remarks from a design reference data base and describing them at designated positions of the two-dimensional projection drawing can be added.

Further, the present invention provides an automatic drawing creation system including an attribute value data base that stores data concerning attribute values of a product, a three-dimensional model data base that stores a three-dimensional model data of the product, a drawing frame data base that stores a drawing frame data on every application uses, projection drawing creation means that extracts the designated drawing frame from the drawing frame data base, and projects the three-dimensional model extracted from the three-dimensional model data base on the extracted drawing frame and thereby creating a two-dimensional projection drawing, a dimension data base that stores data concerning a plurality of dimension line elements, compounding means that extracts dimension line elements in accordance with the shape of the two-dimensional projection drawing from the dimension data base, deforms them in accordance with the attribute values of the product and compounds the deformed dimension line elements and the two-dimensional projection drawing, and drawing output means that outputs the two-dimensional projection drawing compound by the compounding means as a drawing.

According to the means described above, in the course of projecting the three-dimensional model to create the two-dimensional projection drawing, since the dimensional line elements in accordance with the shape of the two-dimensional projection drawing from the dimension data base, which are deformed in accordance with the attribute values of the product, and the deformed dimension line elements and the two-dimensional projection drawing are compounded to output the drawing, only the necessary dimension lines can be described automatically on the two-dimensional drawing when the two-dimensional drawing is created automatically, an operation of deleting unnecessary dimension lines or adding necessary dimension lines is becomes unnecessary thereby enabling to save labor for creating the drawings.

In constituting the automatic drawing creation system, the following elements can be added. A design reference data base that stores data of tolerance values concerning each of the dimension line elements and remarks is provided, and the compounding means extracts the designated tolerance values and remarks from the design reference data base and describes them at designated positions on the two-dimensional projection drawing when the deformed dimension line elements and the two-dimensional projection drawing are compounded.

Further, the invention also concerns a program for casing a computer to execute a processing attained in each of the means described above and a memory medium for storing the program. The memory medium includes, for example, memory means such as CD-ROM and DVD-ROM.

### BRIEF DESCRIPTION OF THE DRAWINGS

FIG. 1 is a basic constitutional view of an automatic drawing creation system according to the present invention.

FIG. 2 is a block diagram showing an example of an automatic drawing creation system according to the present invention.

FIG. 3 is a flow chart for explaining a processing method of automatic drawing creation means 22.

FIG. 4 is a view for explaining a method of utilizing a dimension data base.

FIG. 5 is a flow chart for explaining the operation when a necessary dimension line is added.

FIGS. 6A and 6B are views showing an expression example of a screen used upon adding a necessary dimension line.

FIG. 7 is a flow chart for explaining a processing upon deleting an unnecessary dimension line.

FIGS. 8A to 8D are views showing an expression example of a screen used upon deleting an unnecessary dimension line.

### DESCRIPTION FOR REFERENCES

10 product specification determination means
12 three-dimensional model data base
14 attribute value data base
16 dimension data base
18 drawing frame data base
20 design reference data base
22 automatic drawing creation means
24 drawing representation means

### BEST MODE FOR PRACTICING THE INVENTION

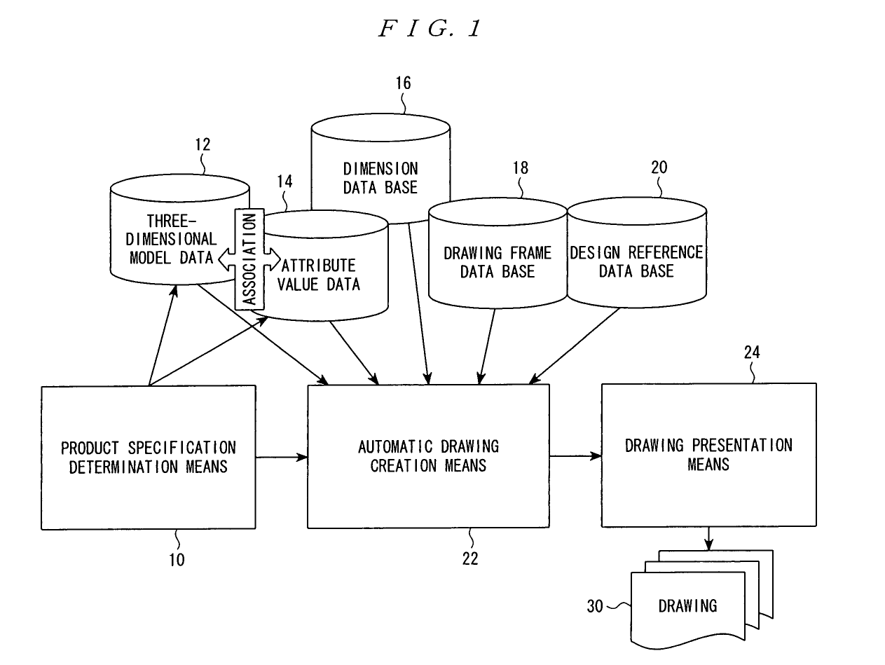

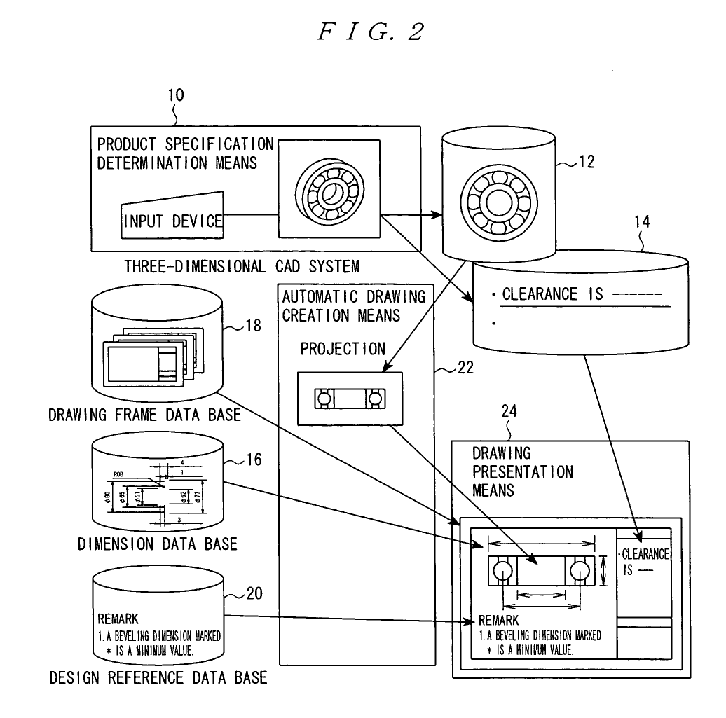

Now, a preferred embodiment of the present invention is to be described with reference to the drawings. FIG. 1 is a basic constitutional view of an automatic drawing creation system according to the present invention. FIG. 2 is a block diagram showing an example of an automatic drawing creation system according to the present invention.

In FIG. 1 and FIG. 2, the automatic drawing creation system according to the invention includes a computer source comprising a processing device source, a memory source, an input/output device, and an interface. Specifically, it comprises a product specification determination means 10 as the input device, a three-dimensional model data base 12, an attribute value data base 14, a dimension data base 16, a drawing frame data base 18, and a design reference data base 20 as the memory source, and an automatic drawing creation means 22 as the processing device source and the interface and, further, comprises a drawing presentation means 24 as the output device.

The product specification determination means 10 is constituted, for example, by using a three-dimensional CAD system, and conducts product design on the three-dimensional CAD system based on the data on the basis of a user's operation, faithfully expresses a real shape of a product into a three-dimensional model, and can extract plan views of the various product such as cross sectional views depending on the design intention. Then, when a user operates the three-dimensional CAD system to prepare a product model, it conducts mathematical calculation for consideration of functions necessary for the product, holds the data concerning dimension values and attribute values inherent to the product in association with the three-dimensional model based on the rules necessary for design and production, stores the data concerning the three-dimensional model in the three-dimensional model data base 12, and store the data concerning the attribute values in association with the attribute value data base 14 respectively. The drawing frame data on every application uses are stored in the drawing frame data base 18, the data concerning a plurality of dimensional line elements are stored in the dimension data base 16, and the data for the tolerance values concerning each of the dimensional line elements and remarks are stored respectively in the design reference data base 20. In this case, graphic forms such as a cross section necessary for the drawing are selected among the coded form list and stored in a state being associated with the three-dimensional model. Further, data such as for the dimension values are adapted such that they can be taken out optionally by specifying the three-dimensional model.

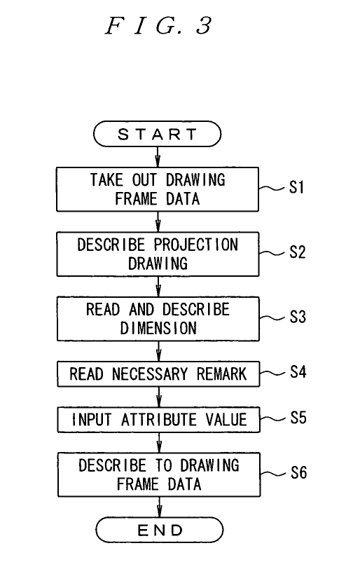

As shown in FIG. 3, the automatic drawing creation means 22 takes out necessary drawing size and drawing form by selecting them from the drawing frame data base 18 in accordance with the purpose of using the drawing to be prepared by a user (step S1). A drawing frame designated by a customer to be used as a drawing for submission to the customer, a drawing frame for production drawing in order to transmit necessary information to production, etc. are previously registered therein, and the data stored in the drawing flame data base 18 can optionally be extended for registration.

Then, based on the selected drawing frame data (file), a graphic form that defines the product is projected from the three-dimensional model thereon and described at a predetermined position on the drawing form (step S2). In this case, based on the shape code stored together with the three-dimensional model, a dimension data controlled for the size by the dimension value is added on the projection drawing. That is, a processing of calling a necessary dimension and describing the content thereof is conducted (step S3).

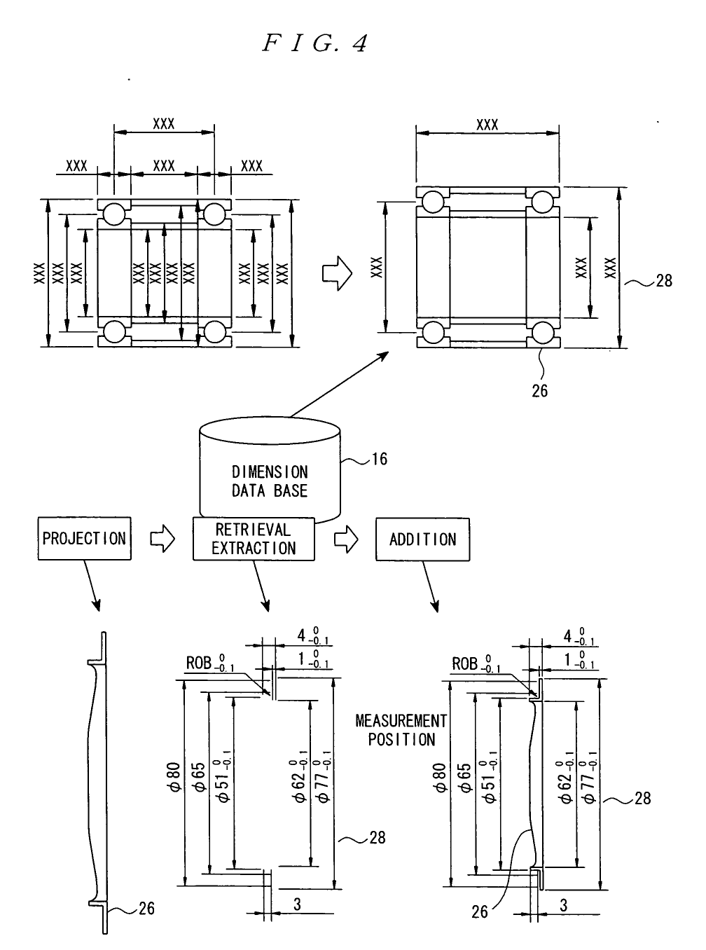

For example, as shown in FIG. 4, a graphic form 26 projected from the three-dimensional model and dimension line elements 28 necessary for the graphic form 26 are separated and held being patterned on every shapes and, for adding necessary dimension elements among a plurality of dimension elements 26, the dimension line elements 28 are deformed depending on the shape of the graphic form 26 in accordance with the attribute values of the product and the deformed dimension line elements 28 are added on the two-dimensional projection drawing. That is, the automatic drawing creation means 22 has a function as the projection drawing creation means of extracting a designated drawing frame from the drawing frame data base 18, projecting the three-dimensional model extracted from the three-dimensional model data base 12 on the extracted drawing frame, to create a two-dimensional projection drawing, as well as has a function as compounding means of extracting the dimension line elements 28 in accordance with the shape of the two-dimensional projection drawing from the dimension data base 16, deforming them in accordance with the attribute values of the product and compounding the deformed dimension line elements 28 and the two-dimensional projection drawing.

Then, the automatic drawing creation means 22 reads out necessary remarks from the design reference data base 20 (step S4), further extracting and inputting the attribute values that change in accordance with the design from the attribute value data base 14 (step S5), and describes the read out remarks and the attribute values respectively at the designated positions on the drawing frame (step S6). As described above, the automatic drawing creation means 22 projects the three-dimensional model to create the two-dimensional projection drawing, extracts the dimension line elements 28 in accordance with the shape of the two-dimensional projection drawing from the dimension data base 16, deforms them in accordance with the attribute values of the product, compounds the deformed dimension line elements 28 and the two-dimensional projection drawing, automatically creates the drawing in accordance with the two-dimensional projection drawing and outputs the data concerning the created drawing to the drawing presentation means 24.

The drawing presentation means 24 can present the drawing created by the automatic drawing creation means 22 to the user as the drawing 30 or output the drawing 30 as printed matters.

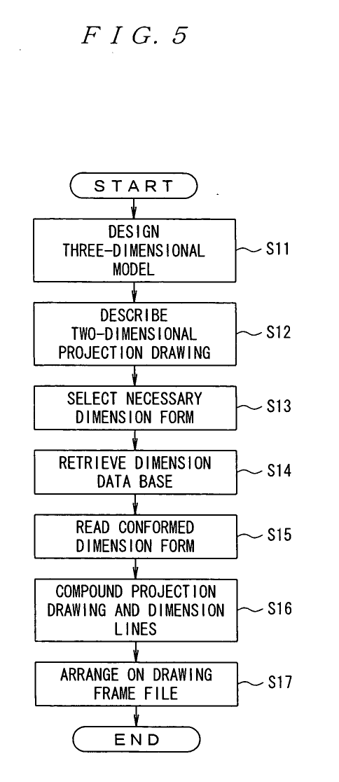

Then, an operation of adding only the necessary dimension lines upon describing only the necessary dimension line elements in the course of automatically creating the two-dimensional drawing based on the three-dimensional model is to be described with reference to the flow chart in FIG. 5.

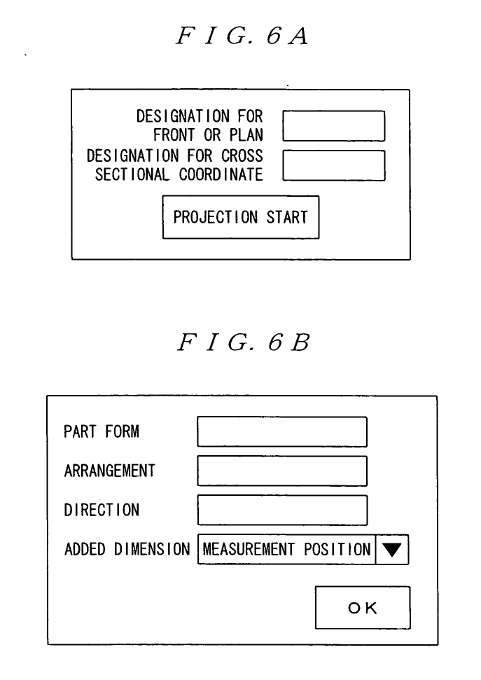

At first, when a three-dimensional model is designed on the three-dimensional CAD system (step S11) and the three-dimensional model is projected as a two-dimensional projection drawing, a necessary projection drawing is described at a predetermined position on the drawing frame (step S12). In this case, as shown in FIG. 6A, a screen regarding designation for the front or plan view and designation for the cross sectional coordinate is displayed on the screen of the three-dimensional CAD system and, when the projection start is selected, necessary projection drawings are described successively at predetermined positions on the drawing frame.

Then, a necessary dimension form is selected (step S13). In this step, as shown in FIG. 6B, a dimension form selection screen for selecting a part form, arrangement, direction, addition method (measurement position) is displayed on the screen of the three-dimensional CAD system. In this case, a necessary dimension form is selected by selecting and inserting optional information to each of the items on the displayed screen.

Then, the dimension data base 16 is retrieved (step S14), the dimension form in accordance with the shape of the two-dimensional projection drawing is read (step S15), read out dimension lines and the projection drawing are compounded (step S16), the compounded drawing is arranged on the drawing frame file (step S17), and only the necessary dimension lines are added in the drawing by the two-dimensional projection drawing.

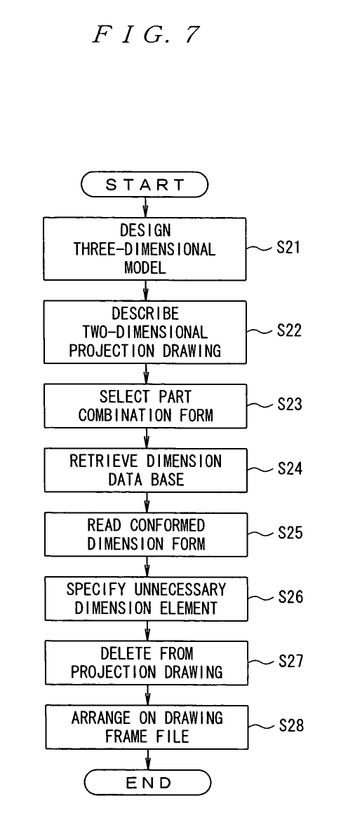

Then, the operation of deleting unnecessary dimension lines is to be described in accordance with the flow chart of FIG. 7.

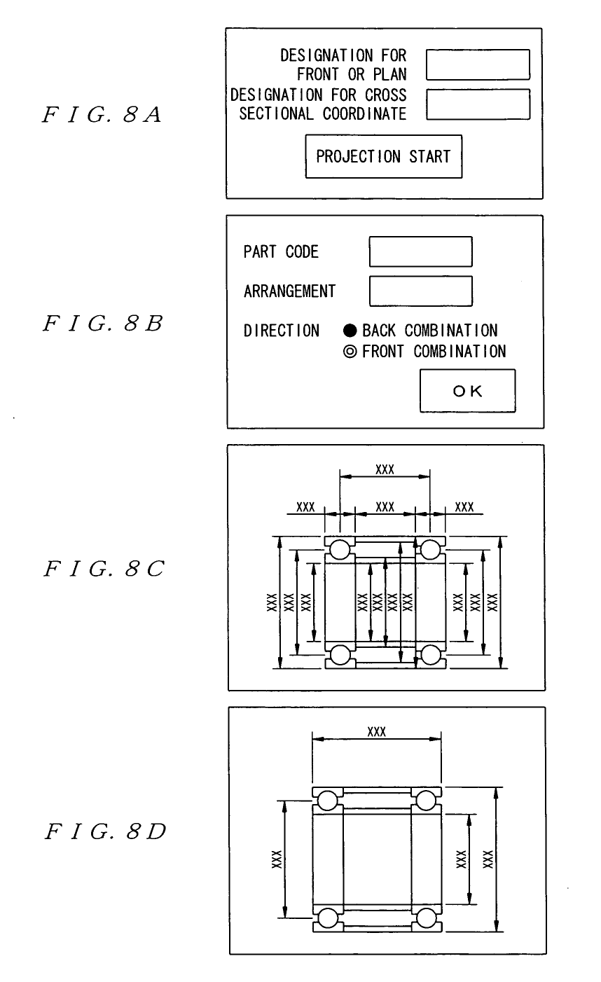

At first, a three-dimensional model is designed on the three-dimensional CAD system (step S21), the three-dimensional model is projected to create a two-dimensional projection drawing, and necessary information is described on the two-dimensional projection drawing (step S22). In this case, as shown in FIG. 8A, a screen for inducing the designation for the front or plan view and the designation for the cross sectional coordinate is displayed on the screen of the three-dimensional CAD system. When the operation of starting projection is conducted, a necessary projection drawing is described at the predetermined position on the drawing frame of the two-dimensional projection drawing. Then, the form of combining parts is selected (step S23). In this case, as shown in FIG. 8B, a screen for selecting and inserting optional information to each of the items for the part code (part number) and arrangement and selecting any one of the directions (back combination or front combination) is displayed on the screen of the three-dimensional CAD system. Then, when each of the items is selected, the dimension data base 16 is retrieved (step S24) and, as shown in FIG. 8C, dimension line elements regarding the two-dimensional projection drawing are displayed together with the projection drawing on the screen of the three-dimensional CAD system.

Then, the dimension line elements in depending on the shape of the two-dimensional projection drawing are deformed in accordance with the attribute values of the product, a dimension form conforming the attribute values of the product is read (step S25), unnecessary dimension elements are specified (step S26), and the dimension elements specified as unnecessary dimension elements are deleted from the projection drawing (step S27). After deleting of the unnecessary dimension line elements, necessary dimensional line elements and two-dimensional projection drawing are compounded and arranged on the drawing frame file (step S28). Thus, as shown in FIG. 8D, necessary dimension line elements are described only at the predetermined positions on the drawing frame of the two-dimensional projection drawing and a screen eliminated with unnecessary dimension lines is displayed on the screen of the three-dimensional CAD system.

As described above, in this embodiment, when the two-dimensional projection drawing is created based on the three-dimensional model and the two-dimensional projection drawing and the dimensional line elements are compounded, since only the necessary dimensional line elements are compounded with the two-dimensional projection drawing, it is possible to save complicate operations of eliminating unnecessary dimension lines or, on the other hand, adding necessary dimensional lines on every parts and contribute to saving of labor in the creation of the drawings.

### INDUSTRIAL APPLICABILITY

According to the present invention, when the two-dimensional drawing is created automatically, only the necessary dimensional lines can be automatically described on the two-dimension drawing to save labor in creating the drawings.

1. An automatic drawing creation method of constructing a three-dimensional model by using a computer source having a processing device source, a memory source, an input device and an interface, in which the processing device source executes a processing including; a step of extracting a designated drawing frame from a drawing frame data base that stores drawing frame data on every application uses, a step of projecting a three-dimensional model extracted from a three-dimensional model data base on the extracted drawing frame thereby creating a two-dimensional projection drawing, a step of extracting dimensional line elements in accordance with the shape of the two-dimensional projection drawing from a dimension data base that stores data concerning a plurality of dimensional line elements and deforming them in accordance with attribute values of a product, and a step of compounding the deformed dimension line elements and the two-dimensional projection drawing and outputting the two-dimensional projection drawing as a drawing, based on the operation program of the memory source.

2. The automatic drawing creation method according to claim 1, the method including a step of extracting designated tolerance values and remarks from a design reference data base and describing them at designated positions on the two-dimensional projection drawing when the deformed dimension line elements and the two-dimensional projection drawing are compounded.

3. An automatic drawing creation system including an attribute value data base that stores data concerning the attribute values of a product, a three-dimensional model data base that stores three-dimensional model data of the product, a drawing frame data base that stores drawing frame data on every application uses, projection drawing creation means that extracts the designated drawing frame from the drawing frame data base, and projects the three-dimensional model extracted from the three dimensional model data base on the extracted drawing frame thereby creating a two-dimensional projection drawing, a dimension data base that stores data concerning a plurality of dimension line elements, compounding means that extracts the dimension line elements in accordance with the shape of the two-dimensional projection drawing from the dimension data base, deforms them in accordance with the attribute values of the product and compounds the deformed dimensional line elements and the two-dimensional projection drawing, and drawing output means that outputs the two-dimensional projection drawing compound by the compounding means as a drawing.

4. The automatic drawing creation system according to claim 3, wherein
the system includes a design reference data base that stores data of tolerance values concerning each of the dimension line elements and remarks, and
the compounding means extracts designated tolerance values and remarks from the design reference data base and describes them at designated positions on the two-dimensional projection drawing when the deformed dimension line elements and the two-dimensional projection drawing are compounded.

5. An automatic drawing creation program containing a program for causing a computer to execute a processing attained with each of the means according to claim 3.

6. A computer-readable memory medium that stores the automatic drawing creation program according to claim 5.
